(19) United States
(12) Patent Application Publication
(10) Pub. No.: US 2013/0050010 A1
(43) Pub. Date: Feb. 28, 2013

(54) DEVICE AND METHOD FOR ASSESSING A POTENTIAL TARGET

(71) Applicant: Per-Åke Nordlander, Bjasta (SE)

(72) Inventor: Per-Åke Nordlander, Bjasta (SE)

(21) Appl. No.: 13/634,503

(22) PCT Filed: Mar. 17, 2011
(86) PCT No.: PCT/SE2011/050289

§ 371 Date: Nov. 12, 2012

(30) Foreign Application Priority Data
Mar. 17, 2010 (SE) 1050240-9

(51) Int. Cl. G01S 13/78; G01S 17/74

(52) U.S. Cl. 342/45

(57) ABSTRACT

The invention relates to a method for assessing, from a firing unit (101), a potential target (102) for said firing unit, comprising the steps of:—visually observing said potential target (102) through direction means;—initiating measuring of a range from said firing unit (101) to the potential target (102) by means of delivering an identifiable signal (S1);—at said potential target, receiving and analysing said signal (S1), said analysis comprising establishing that at least one of the parameters power, frequency, and durability configuration of said signal (S1)—comparing said at least one parameter with parameter indications stored in advance;—on correspondence, establishing that the firing unit belongs to own troop; and—delivering a visual signal (S2) from the potential target (102). The invention also relates to a computer program product comprising a program code (P) for a computer (200; 210) for implementing a method according to the invention. The invention also relates to a system and a firing unit being equipped with the device.

### TECHNICAL FIELD

The present invention relates to a method for assessing, from a firing unit, a potential target for said unit. The invention also relates to a computer program product comprising program code for a computer for implementing a method according to the invention. The invention also relates to a system for assessing a potential target and a firing unit.

### BACKGROUND

During armed conflicts indirect fire is used for e.g. fighting hostile units within a predetermined area. This may occur by means of artillery fire in a conventional way. Indirectly fire may also be used for fighting one or several hostile units the respective position of which having been fairly precisely determined. The firing units hereby fighting units within a predetermined area or individual units in this way are according to an example arranged to receive information comprising targets coordinates from a command and subsequently open effective fire on the basis of these. Usually set weapons of the firing unit are adjusted at least once on the basis of observed hit rate. Battles with indirect fire are characterized by relatively long time courses between a point of time when the target is observed till the target may be fought. Further, battles with indirect fire are characterized by long ranges between the firing unit and the target to be fought, such as e.g. 10 kilometre or tenths of kilometres. During battles with indirect fire the normal case is that the firing unit may not observe the target visually, i.e. with the human eye.

During armed battles battle methods with direct fire is also used. Direct fire is characterized by relatively short time courses between a point of time when the target is observed until the target may be fought. Further battles with direct fire are characterized by short distances between the firing unit and the target to be fought, such as e.g. 500 metres to 2 kilometres. During battles with direct fire the normal case is that the firing unit may observe the target visually.

Under circumstances comprising potential direct firing situations are created as a consequence of the short time courses, being experienced as stressful for operators of the firing unit, such as e.g. carriage chief and a shot. The shot of the firing unit must within a short time period after visual observation of a potential target determine the position of the target and speed for facilitating aligning of weapon systems of the firing unit. Further, the shot or other operators of the firing unit assess the target in so far that a determination of whether the target is a hostile unit or a unit within own troop must be performed.

Certain military vehicles of today are equipped with a device for discovering and identifying laser light. This device is used as support system for a crew on said vehicle. The device may warn the crew if the vehicle is illuminated with laser light from e.g. a telemeter or laser controlled weapon.

In a case where the crew is warned that the own vehicle is illuminated it may take measures such as e.g. fire smoke-grenades, do evasive manoeuvres or turn a weapons system of the vehicle in the direction of threat for fighting the firing unit having generated the laser light for measuring in.

In situations where fighting with direct fire is compelled to be used too often it occurs that units within own troop are fought by mistake, among others due adequate support systems lacking or being insufficient. There is thus a need for reducing the risk for any from the firing unit fighting a unit within own troop.

U.S. Pat. No. 5,142,288 describes an IFF-system and shows transmitting of a response signal from a target platform in the case that the target platform belongs to the own troop in connection to the announcement from a weapon platform.

### SUMMARY OF THE INVENTION

An object of the present invention is to provide a new and advantageous method for reduction the risk of fighting, from a firing unit, a unit within own troop.

Another object of the invention is to provide a new and advantageous system and a new and advantageous computer program for reducing the risk of fighting, from a firing unit, a unit within own troop.

Yet another object of the invention is to provide a method, a system and a computer program for providing a reliable support function for an operator of a firing unit during a situation comprising potential direct firing.

Yet another object of the invention is to provide a method, a system and a computer program for minimizing, in a user friendly way, own losses during a situation comprising potential direct firing.

Yet another object of the invention is to provide a method, a system and a computer program for providing a time efficient way of assessing whether a visually observed potential target is friend or enemy.

Yet another object of the invention is to provide a method, a system and a computer program for providing a simple and robust way of assessing whether a visually observed potential target is friend or enemy.

These and other objects are achieved with a method for assessing, from a firing unit, a potential target for said unit according to claim 1.

According to an aspect of the invention a method is provided for assessing, from a firing unit, a potential target for said firing unit, comprising the steps of:
visually observing said potential target through direction means;
initiating measuring of a range from said firing unit to the potential target by means of delivering an identifiable signal;
at said potential target, receiving and analysing said signal, said analysis comprising establishing at least one of the parameters effect, frequency, and durability configuration of said signal.

The method also comprises the steps of:
comparing said at least one parameter with parameter indications stored in advance;
on correspondence, establishing that the firing unit belongs to own troop; and
delivering a visual signal from the potential target.

By the utilization of a visual response signal according to above the effect that an operator (shot) directly without time delay is given the possibility to determine if illuminated potential target is friend or enemy due to the visual response signal, wherein the determination concerning if the potential target is a friend or enemy may be done quicker. Further the system becomes more user friendly in that the operator directly in sight may determine if the potential target is enemy or friend without moving the eyes from the potential target to a display panel, indicator or the like. Further the risk for misinterpretations due to incoming reflection signals originating from the illuminated target.

The inventive method is particularly suitable for combat situations where direct fire possibly is desired to be delivered at a potential target. A shot of the firing unit may according to an aspect of the invention after measuring of the potential target, in the case the potential target is a unit within own troop, automatically receive feedback by means of a visual indication of the potential target. The visual indication may be provided by means of the visual signal. The visual signal may during daylight be a visual signal being visible for the human eye through a sight of the firing unit and the wave length of the signal thereby lying within a wave length range of 390-770 nm. The visual signal may alternatively be a visual signal being visible for e.g. a CCD-camera of the firing unit and the wave length of the signal thereby lying within a wave length range of 700-100 nm. The visual signal may alternatively be a visual signal being visible for e.g. a thermal camera of the firing unit and the wave length of the signal thereby lying within a wave length range of 3.0-5.0 micrometres or 8.0-12.0 micrometres. The visual indication states that a firing of said potential target means a risk for fighting of an own unit within own troop. In the case a unit within the own troop is illuminated by laser light this unit may automatically give visual feedback to the firing unit where an assessment whether the potential target is hostile or not is facilitated.

The analysis of the laser light of the illuminated unit within own troop may according to an aspect of the invention be effected within a very short range of time, such as e.g. some tenths of seconds. If it is established that firing of said potential target means risk for fighting of a unit within own troop the shot may in an efficient and safe way get an indication thereof. Thereby is facilitated to interrupt a planned attack with direct fire on the potential target.

Said identifiable signal may be a radar signal, laser signal or IR-laser signal.

By using a radar signal for estimation of distance a method of measuring in which does not give any visual tracks is achieved. Use of a radar signal thus makes it practically impossible for a hostile unit to visually observe from where the telemetry has been initiated, delivering a relatively safe method for determination of range.

By using a laser signal for determination of range a method of measuring in delivering a very precise estimation of range is achieved.

By using an IR laser signal for estimation of range a method of measuring in not delivering any visual tracks is achieved. Use of an IR radar signal thus makes it practically impossible for a hostile unit to visually observe from where the telemetry was initiated, delivering a relatively safe method for estimation of range. In addition performing reliable estimations of ranges under conditions with reduced sight, e.g. in darkness during night time is facilitated.

Said parameter indications may comprise information about any of the parameters effect and/or frequency and/or durability configuration for a signal generated by a measuring in equipment of at least one unit within own troop. The radar signals, laser signals and IR laser signals being used may be a predetermined effect, wavelength (frequency) and durability configuration. By using identifiable signals for measuring in of range, which signals having predetermined characteristics, efficient analysis of a receiving unit (potential target) within the nit for determining whether the signal delivering firing unit is friend or enemy is facilitated.

The visual signal may be delivered from the potential target in a direction towards the firing unit. Hereby a reduced risk of e.g. hostile units being within the same geographical area as the signal delivering firing unit and the receiving firing unit, detecting presence of the same if achieved.

The visual signal may be light visible for the human eye and may thereby be an arbitrary suitable wavelength, e.g. between 390-770 nm, or as an example between e.g. 490 and 560 nm, i.e. green light. The visual signal may be visible light of arbitrary effect and durability configuration.

The visual signal may be light visible for an arbitrary electronic-optic equipment and may thereby be of arbitrary suitable wavelength, e.g. between 700-1000 nm. The visual signal for arbitrary electronic-optic equipment may be a signal of arbitrary effect and durability configuration.

The visual signal may be light visible for an arbitrary electronic-optic equipment and may thereby be of arbitrary suitable wavelength, e.g. between 3.0-5.0 micrometre or 8.0-12.0 micrometre. The visual signal for arbitrary electronic-optic equipment may be a signal of arbitrary effect and durability configuration.

The method may further comprise the steps of, at the potential target:
establishing a direction from which the identifiable signal was received;
storing information about said established direction;
choosing a delivering direction for said visual signal.

In the case the potential target is moving it is advantageously facilitated to chose a delivering direction or said visual signal such that this may be observed visually in the signal delivering firing unit even during movement and possible direction of course of the potential target. This is performed automatically, wherein a user friendly method of reducing risk for fighting of own troop is provided.

The method is according to an aspect of the invention easy to implement in existing firing units, such as e.g. military vehicles of different kind, such as e.g. combat vehicles or tanks. Software for determining if own unit is illuminated by a firing unit within own troop may according to the invention be installed in a control unit of all firing units within own troop during manufacturing of the same. A purchaser of such firing unit may get the possibility to chose the function of the method as a choice. Alternatively the software comprising program code for performing the inventive method for indicating own troop property for a firing unit within own troop may be installed in a control unit of the firing unit during upgrade after purchase. In this case relevant software may be loaded in a memory in the control unit.

Software comprising program code for facilitating assessment of a potential target for a firing unit may easily be upgraded or exchanged. Further, different parts of the software comprising program code for facilitating assessment of a potential target for a firing unit may be exchanged independently of each other. This modular configuration is advantageous from a maintenance perspective.

According to an aspect of the invention a system is provided for assessing, from a firing unit a potential target for said firing unit, comprising:
means through which said potential target visually may be observed;
means for initiating measuring of a range from said firing unit to the potential target by means of means for delivering an identifiable signal;
at said potential target, means for receiving and analysing said signal, said analysis comprising establishing at least one of the parameters effect, frequency, and durability configuration of said signal. The system also comprises:
means for comparing said at least one parameter to parameter indications stored in advance;
means for establishing that the firing unit belongs to own troop, in the case correspondence exists between said at least one parameter and said parameter indications; and
means for delivering a visual signal from the potential target.

The system may further comprise:
means for establishing a direction from which the identifiable signal was received;
means for storing information about said established direction;
means for choosing a delivered direction for said visual signal.

According to an aspect of the invention a firing unit is provided, comprising:
means for receiving and analysing an identifiable signal from a signal delivering firing unit, wherein said identifiable signal is intended for measuring in a distance from said signal delivering firing unit to a receiving firing unit, said analysis comprising establishing at least one of the parameters effect, frequency, and durability configuration of said signal. The firing unit further comprises:
means for comparing said at least one parameter to parameter indications stored in advance;
means for establishing that the signal delivering firing unit belongs to own troop, in the case correspondence exists between said at least one parameter and said parameter indications; and
means for delivering a visual signal to the signal delivering firing unit, for indicating, from said receiving firing unit, that said receiving firing unit does not constitute a potential target for said signal delivering firing unit.

The firing unit may be a military vehicle, such as e.g. a combat vehicle, a tank or a tracked vehicle. The firing unit may be a surface combat vessel, such as e.g. a combat boat. The firing unit may be a helicopter.

According to an aspect of the invention a computer program is provided, for facilitating assessing from the first firing unit a second firing unit as a potential target for said first firing unit, said computer program comprising program code stored on a, by a computer readable, medium for causing an electronic control unit, or another computer connected to the electronic control unit, of the second firing unit, for performing the steps of:
analysing an identifiable signal having been received from said first firing unit, wherein said identifiable signal is intended for measuring in of a range from said first firing unit to the second firing unit, said analysis comprising establishing at least one of the parameters effect, frequency, and durability of said identifiable signal;
comparing said at least one parameter with parameter indications stored in advance;
at correspondence, establishing that the first firing unit belongs to own troop; and
delivering a visual signal from the second firing unit for indicating that the second firing unit does not constitute a potential target for said first firing unit.

According to an aspect of the invention a computer program is provided for facilitating assessing, from a first firing unit, a second firing unit being a potential target from said first firing unit, said computer program comprising program code store on a, by a computer readable, medium for causing an electronic control unit, or other computer connected to the electronic control unit, of the second firing unit, for performing, when run on a computer, the steps of:
analysing an identifiable signal having been received from said first firing unit, wherein said identifiable signal is intended for measuring in of a range from said first firing unit to the second firing unit, said analysis comprising establishing at least one of the parameters effect, frequency, and durability of said identifiable signal;
comparing said at least one parameter with parameter indications stored in advance;
at correspondence, establishing that the first firing unit belongs to own troop; and
delivering a visual signal from the second firing unit for indicating that the second firing unit does not constitute a potential target for said first firing unit.

According to an aspect of the invention a computer program product is provided comprising a computer program with a program code store on a, by a computer readable, medium for performing the method steps of:
analysing an identifiable signal having been received from said first firing unit, wherein said identifiable signal is intended for measuring in of a range from said first firing unit to the second firing unit, said analysis comprising establishing at least one of the parameters effect, frequency, and durability of said identifiable signal;
comparing said at least one parameter with parameter indications stored in advance;
at correspondence, establishing that the first firing unit belongs to own troop; and
delivering a visual signal from the second firing unit for indicating that the second firing unit does not constitute a potential target for said first firing unit, when said computer program is run on an electronic control unit or other computer connected to the electronic control unit of the second firing unit.

Further objectives, advantages and new features of the present invention will appear for the skilled person from the following details, as well as via exercise of the invention. While the invention is disclosed below it should be apparent that the invention is not limited to the specific details described. Skilled persons having access to the teaching herein will recognize further applications, modifications and incorporations within other fields being within the scope of the invention.

### DESCRIPTION OF THE DRAWINGS

FIG. 1 schematically illustrates a firing unit, according to an embodiment of the invention;

FIG. 2 schematically illustrates a subsystem to the firing unit shown in FIG. 1, according to an embodiment of the invention;

FIG. 3 shows an overview of a number of units present within a geographical area;

FIG. 4a schematically illustrates a flow chart over a method for assessing, from a firing unit, a potential target for said unit, according to an embodiment of the invention;

FIG. 4b schematically illustrates in more detail a flow chart over a method for assessing, from a firing unit, a potential target for said unit, according to an embodiment of the invention; and

FIG. 5 schematically illustrates a computer, according to an embodiment of the invention.

### DETAILED DESCRIPTION OF THE FIGURES

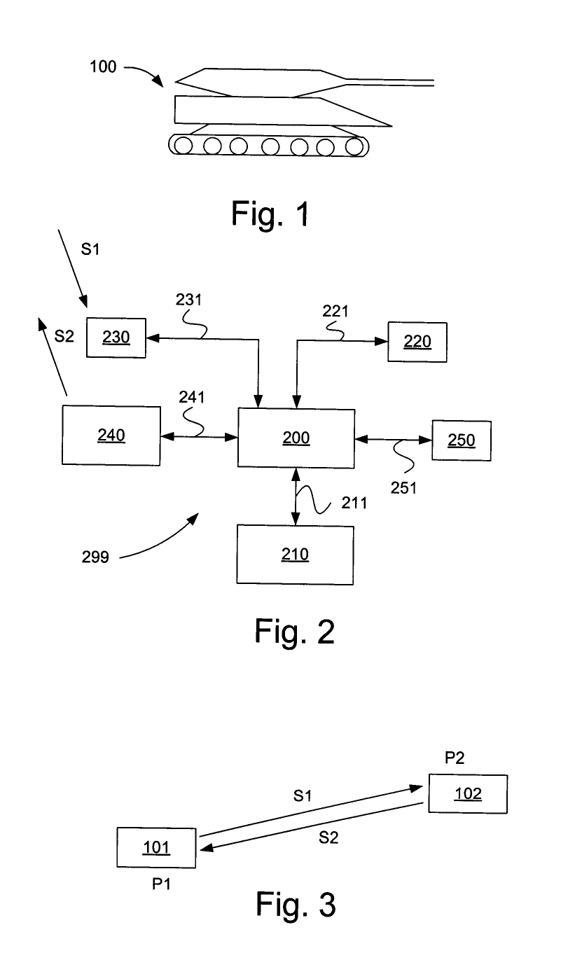

With reference to FIG. 1 a side view of a firing unit 101 is shown. The exemplified firing unit 101 is a military vehicle, such as e.g. a motorised combat vehicle or a tank. According to this example the firing unit 101 is a tank. According to a preferred embodiment the vehicle 101 is a military vehicle with a weapons system onboard. The firing unit 101 may be a wheeled vehicle, such as e.g. a four-wheeled, six-wheeled or eight-wheeled motor vehicle. The firing unit 101 may be a tracked vehicle, such as e.g. a tracked carriage. The firing unit 101 may be an armed cross-country vehicle of arbitrary kind.

According to an alternative embodiment the firing unit is a stationary firing unit, such as a stationary military plant. Herein the firing unit 101 is described as a tank, but it should be mentioned that the invention also is realisable and implementable in an armed water vessel, such as e.g. a surface combat vessel, such as a combat boat. According to an alternative embodiment the firing unit is a helicopter being part of a troop of cooperating helicopters.

According to an embodiment a troop may be composed of a combination of the above exemplified firing units.

Herein the term “link” is referred to as a communication link which may be a physical line, such as an opto-electronic communication line, or a non-physical line, such as a wireless connection, e.g. a radio link or microwave link.

According to an example described herein the firing unit 101 is a tank having a number of operators performing determined assignments. The tank 101 is lead by carriage chief. Another operator onboard the tank is a shot having e.g. the assignment to visually observe potential targets and, if it is determined that the potential target is hostile, fighting the observed target. In order to be able to align the canon of the tank in a correct way the shot firstly performs an estimation of the distance for establishing a distance to the potential target relative to an own position. In order to be able to align the canon of the tank in a correct way the shot may also establish a speed of the potential target.

Herein the term “troop” or “own troop” refers to an arbitrary troop with units, comprising one or several firing units, which troop may be a military unit, such as e.g. an armoured platoon or an armoured company.

With reference to FIG. 2 a subsystem 299 of the firing unit 101. The subsystem 299 is arranged in the firing unit 101.

The subsystem 299 comprises a first control unit 200. The first control unit 200 is arranged for communication with a direction means module 220 via a link 221. The direction means module 220 comprises a sight for visual observation of a surrounding of the firing unit 201. The direction means module 220 is particularly suitable for visually observing a potential target. The direction means module 220 may comprise image enlargement members of suitable kind for facilitating efficient observing of a potential target at a relatively long distance.

The direction means module 220 is arranged with a measuring in unit. The measuring in unit is arranged to measure in a range to a visually observed target relative to own position. Measuring in of said range may be initiated manually by the shot by delivering an identifiable signal S1 in the form of laser light towards the potential target and detect a reflection of the light for thereby facilitating calculation of said range.

The direction means module 220 is according to an example arranged to establish a distance to a visually observed target relative to own position by means laser light, radar waves or sound waves. The direction means module 220 is arranged to automatically transmit a signal comprising information about the established range to the first control unit 200 via the link 221.

A shot or other operator of the firing unit 101 may according to an aspect of the invention observe a visual signal delivered from a measured in potential target, where the visual signal lies within a wavelength range of 390-770 nm.

According to an embodiment the direction means module 220 comprises electro-optical equipment in the form of e.g. a CCD-camera and/or a thermal camera which according to an aspect of the invention is sensitive for a visual signal delivered from a measured in potential target, the visual signal lying within a wavelength range of 700-1000 nm and a wavelength range of 3.0-5.0 micrometer or 8.0-12.0 micrometer respectively.

According to an embodiment the electro-optical equipment is arranged so that it utilizes the same optical path as the visible light in the sight. Alternatively the electro-optical equipment may be arranged such that it uses an own optical path for e.g. thermal wavelengths. A monitor for the electro-optical equipment may be presently arranged at the side of the direction means module 220 such that a shot may turn the head somewhat at the side in order to see images being generated by the electro-optical equipment. Thereby the shot or other operator of the firing unit 101 may perceive a visual feedback by a visual signal transmitted from the potential target according to an aspect of the invention.

It should be noted that a shot or other operator of the firing unit 101 may perceive the visual signal being delivered from the potential target either via the human eye or by means of said electro-optical equipment. Said perception may thus occur independent of current light conditions, i.e. during daytime as well as dawn or during night time.

The first control unit 200 is arranged for communication with sensor members 230 via a link 231. The sensor members are arranged to detect identifiable signals S1, such as e.g. signals delivered from a direction means module 220 described above of e.g. a firing unit within own troop. The sensor members 230 are arranged to detect at least any of laser light, IR laser light radar waves or sound signals. The sensor members 230 are arranged to establish a direction from which the identifiable signal s1 has been received. Said direction may be established with great accuracy.

The sensor members 230 are according to a first example arranged to analyse the received identifiable signals S1 for establishing e.g. effect and/or frequency and/or durability configuration of the received signals S1. With durability configuration, a structure of the signal, such as e.g. pulsing or showers is intended. A durability configuration may be a signal pulse being 2.00 seconds long. Another durability configuration may be two signal pulses each being 3.00 seconds with an interruption of 1.00 second. The durability configuration may be a predetermined durability configuration. The durability configuration may be an arbitrary predetermined durability configuration.

The sensor members 230 are according to a firsts example arranged to transfer the received identifiable signals S1 to the first control unit 200 for there facilitating to establishing e.g. effect, frequency and/or durability configuration of the received signals S1.

The sensor members 230 are according to a second example arranged to transfer the received identifiable signals S1 to the first control unit 200 for there facilitating to establishing from which respective direction the identifiable signals have been received.

According to an advantageous embodiment the sensor members 230 comprise a number of detectors for detecting an identifiable signal S1, each detector covering a predetermined angle sector relative to e.g. a fire tube of the firing unit.

According to an advantageous embodiment the sensor members 230 comprises twelve detectors for detecting an identifiable signal S1, each detector covering an angle sector of 30 degrees relative to e.g. a fire tube of the firing unit 101.

The first control unit 200 is arranged for communication with a feedback device 240 via link 241. The feedback device 240 may in a suitable way give a predetermined feedback from a signal receiving firing unit to a signal delivering firing unit according to the invention. The feedback device 240 may comprise means for visual feedback.

The first control unit 200 is arranged to control the feedback device 240 in such a way that a visual signal S2 is delivered in the case where it is established that the signal delivering firing unit is a member in own troop.

The feedback device 240 may consist of at least one lamp or light-emitting diode being arranged to deliver, where applicable, a visual signal S2 in the form of a light signal. The light signal may be of arbitrary effect, wavelength (frequency) and durability configuration. The delivered visual signal S2 facilitates for the shot of the signal delivering firing unit observing the potential target through direction means and initiates the estimation of range to assess that the potential target is a unit within own troop. The visual signal S2 may be as described above and be visible for the human eye as well as for the electro-optical equipment.

The visual signal S2 may have a wavelength lying within a wavelength range of 390-770 nm, 700-1000 nm or a wavelength range of 3.0-5.0 micrometer or 8.0-12.0 micrometres. The electro-optical equipment may be arranged to indicate for a shot or other operator of the firing unit 101 that the visual signal S2 has been received at the firing unit 101 from the potential target.

According to an embodiment the feedback device 240 is arranged on a mast being fixed to the firing unit. According to this embodiment the feedback device is arranged to deliver a circular radiating visual signal S2.

According to an advantageous embodiment the feedback device 240 arranged on a tower on the firing unit 101. According to this embodiment the feedback device 240 is arranged to deliver the visual signal S2 only in one direction towards the signal delivering firing unit.

According to an advantageous embodiment the feedback device 240 comprises a number of lamps being arranged on a tower on the firing unit 101. According to this embodiment delivering the visual signal S2 in a direction towards the signal delivering firing unit is facilitated in an efficient way.

According to an advantageous embodiment the feedback device 240 comprises twelve lamps being arranged on a tower on the firing unit 101. According to this embodiment delivering the visual signal S2 in a direction towards the signal delivering firing unit within an angle sector of 30 degrees is facilitated in an efficient way.

According to an embodiment one of the twelve lamps where arranged at a ditto detector for detecting an identifiable signal S1 coming from a direction within an angle sector of 30 degrees.

The first control unit 200 is arranged for communication with a weapons system 250 via a link 251. The weapons system 250 may be an arbitrary weapons system being arranged for fighting targets, such as e.g. hostile firing units. Examples of hostile firing units may be military vehicles, such as e.g. tanks or combat vehicles being part of a troop other than the own troop.

The weapons system 250 may e.g. be a canon of a tank, a fire tube, or another weapon being suitable for fighting, by means of direct fire, potential threats, such as e.g. a visually observed hostile firing unit.

The first control unit 200 is arranged to receive a signal comprising information about the established distance, and a direction, to a visually observed target relative to own position for the firing unit 101 from the direction means module 220 via the link 221. The first control unit 200 is arranged to adjust the weapons system 250 on the basis of the received signal from the direction means unit 220. This embodiment may comprise targeting a fire tube, such as e.g. a canon of a tank, in such a way that fighting of the visually observed potential target may be performed with direct fire. The adjustment of the weapons system 250 may occur automatically on the basis of the received signal comprising among others relative range to the potential target from the direction means unit 220. The adjustment of the weapons system 250 may occur automatically on the basis of information about an established absolute position for the measured in potential target. The adjustment of the weapons system 250 may occur automatically on the basis of information about an established absolute position for the firing unit 101.

A second control unit 210 is arranged for communication with the first control unit 200 via a link 211. The second control unit 210 may be releasably connected to the first control unit 200. The second control unit 210 may be an external unit to the firing unit 101. The second control unit 210 may be arranged to perform the inventive method steps according to the invention. The second control unit 210 may be used for loading software to the first control unit 200, particularly software for performing the inventive method. The second control unit 210 may alternatively be arranged for communication with the first control unit 200 via an internal network in the firing unit 101. The second control unit 210 may be arranged to perform essentially like functions as the first control unit 200, such as e.g. analysing an identifiable signal S1 as received by the signal receiving firing unit from the signal delivering firing unit, said analysis comprising establishing at least one of the parameters effect, frequency, and durability configuration of said signal S1. The second control unit 210 may be arranged to compare said at least one parameter with parameter indications stored in advance, and at correspondence, establishing that the signal delivering firing unit belongs to own troop. The second control unit may be arranged to deliver a visual signal S2 from the receiving firing unit in a direction towards the signal delivering firing unit.

FIG. 3 shows an overview of two firing units existing within a geographical area. In FIG. 3 the firing unit 101 and a firing unit 102 are shown, which are parts of the same troop.

In this example positions are given in a two-dimensional coordinate system. The firing unit 101 is at an absolute position P1. The firing unit 102 is at an absolute position P2.

Herein the first firing unit 101 and the second firing unit 102 comprises the equipment as e.g. is described with reference to FIG. 2 for the first firing unit 101. The first firing unit 101 is also denominated as signal delivering firing unit. The second firing unit 102 is also denominated as signal receiving firing unit. The first firing unit 101 and/or the second firing unit 102 may be stationary firing units.

According to this example a shot of the signal delivering firing unit observes the signal receiving firing unit 102 visually through direction means. In this position the crew of the firing unit 101 does not know whether the firing unit 102 is a member in own troop or not.

The shot thereafter initiates a measuring of a range from the firing unit 101 to the firing unit 102 by means of delivering an identifiable signal S1, such as e.g. a signal with laser light as a carrier. The firing unit 102 receives and analyses said identifiable signal S1. The analysis is performed automatically and comprises establishing at least one of the parameters effect, frequency, and durability configuration of the received identifiable signal S1. The at least one parameter of the identifiable signal S1 is compared to parameter indications being stored in advance in a memory of a control unit of the receiving firing unit. In the case where the parameter of the identifiable signal S1 corresponds to the parameter indications according to certain criteria it may be established that the signal delivering firing unit 101 belongs to own troop. In this case the signal receiving firing unit 102 delivers a visual signal S2 in the direction towards the signal delivering firing unit 101 for informing the shot that the firing unit 102 also is part of own troop. The shot of the signal delivering firing unit 101 may hereby make sure that the potential target is a member of own troop and prevent initiation of effective fire.

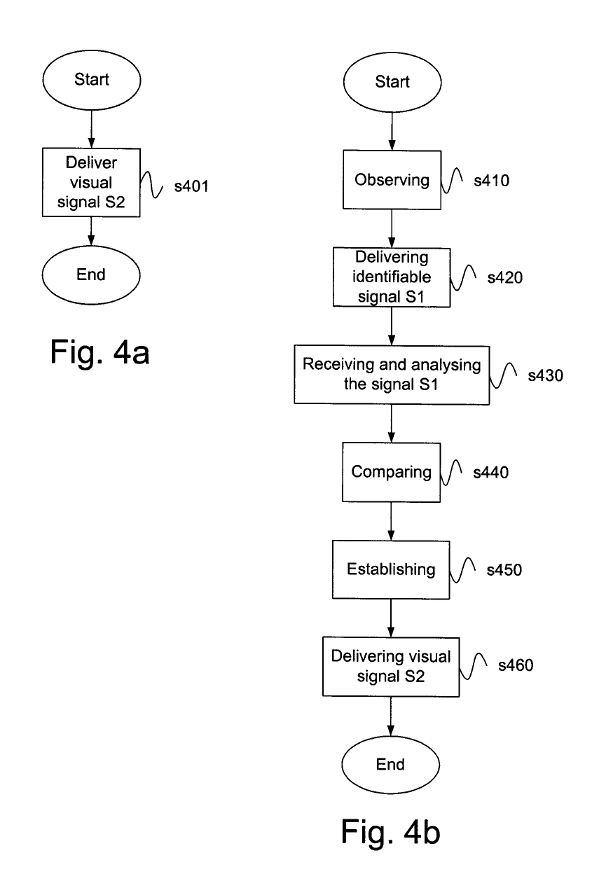

FIG. 4 schematically illustrates a flow chart over a method for assessing, from a firing unit, a potential target for said firing unit, according to an embodiment of the invention. The method comprises a first method step s401. The step s401 comprises the steps of:
visually observing said potential target through direction means;
initiating measuring of a range from said firing unit to the potential target by means of delivering an identifiable signal S1;
at said potential target, receiving and analysing said signal S1, said analysis comprising establishing that at least one of the parameters power, frequency, and durability configuration of said signal S1. The step s401 also comprises the steps of:
comparing said at least one parameter with parameter indications stored in advance;
on agreement, establishing that the firing unit belongs to own troop; and
delivering a visual signal from the potential target.

After the step s401 the method is terminated.

FIG. 4b schematically illustrates a flow chart over a method for assessing, from a signal delivering firing unit, a potential target for said firing unit, according to an embodiment of the invention.

The method comprises a first method step s410. The method step s410 comprises the step of visually observing, from this signal delivering firing unit, said potential target through direction means onboard said firing unit. The shot onboard the firing unit 101 performs this. After the method step s401 a subsequent method step s420 is performed.

The method s420 comprises the step of initiating measuring of a range from the signal delivering firing unit (firing unit 101, as described with reference to FIG. 3) to the potential target (firing unit 102, as described with reference to FIG. 3) by means of delivering an identifiable signal S1. The shot may by means of equipment onboard the signal delivering firing unit manually initiate and perform an estimation of range by delivering the identifiable signal S1 towards the visually observed potential target. The identifiable signal S1 may be a radar signal, laser signal or IR laser signal. After the method step s420 a subsequent method step s430 is performed.

The method step s430 comprises the step of receiving and analysing, at said potential target, said identifiable signal S1, said analysis comprising establishing at least one of the parameters effect, frequency, and durability configuration of said signal S1. This is performed automatically at the potential target. After the method step s430 a subsequent method step s440 is performed.

The method step s440 comprises the step of comparing said at least one parameter with parameter indications stored in advance. The parameter indications stored in advance comprise information about characteristics of identifiable signals being used by own troop. This characteristics comprises information about e.g. effect, frequency and durability configuration of identifiable signals being used by own troop for measuring of ranges to potential targets observed visually through direction means of the firing unit within own troop. After the method step s440 a subsequent method step s450 is performed.

The method step s450 comprises the step of establishing, at correspondence, that the firing unit belongs to own troop. In the case where a comparison between at least one parameter of a received identified signal S1 and a parameter indication stored in advance results in the compared parameters being essentially like it may with fairly high probability be established that the signal delivering firing unit belongs to own troop. According to an example effect, frequency and durability configuration of the identifiable signal S1 with effect, frequency and durability configuration respectively, associated with a known measuring in equipment of at least one kind of firing unit within own troop. After the method step s450 a subsequent method step s460 is performed.

The method step s460 comprises the step of visually delivering a signal S2 from the potential target. In the case where the signal receiving unit may establish that the signal delivering firing unit belongs to own troop a visual signal S2 is automatically delivered in the direction towards the signal delivering firing unit for indicating that a possible planned firing is to be interrupted. A shot of the signal delivering firing unit may thereby interrupt a possible planned effective fire. After the method step s460 the method is terminated.

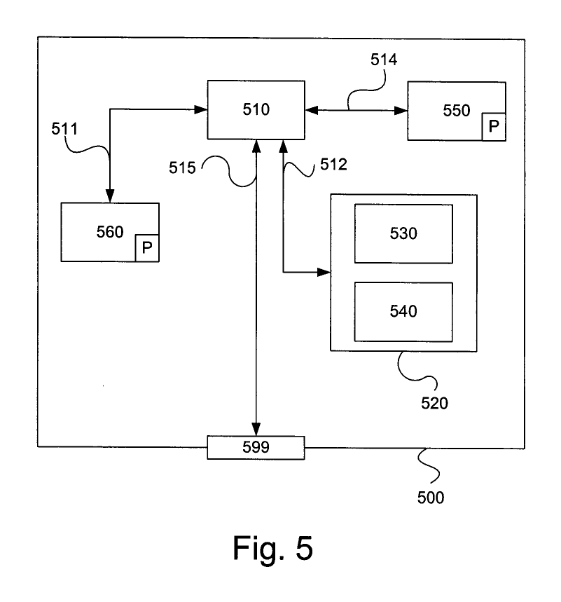

With reference to FIG. 5 a diagram of a method of an apparatus 500 is shown. The control units 200 and 210 being described with reference to FIG. 2 may in an embodiment comprise the apparatus 500. The apparatus 500 comprises a non-volatile memory 520, a data processing unit 510 and a read/write memory 550. The non-volatile memory 520 has a first memory portion 530 wherein a computer program, such as an operating system, is stored for controlling the function of apparatus 500. Further, apparatus 500 comprises a bus controller, a serial communication port, I/O-means, an A/D-converter, a time date entry and transmission unit, an event counter and an interrupt controller (not shown). Non-volatile memory 520 also has a second memory portion 540.

A computer program P is provided, comprising routines for facilitating assessment of a potential target for a firing unit according to the inventive method. The program P comprises routines for analysing a received identifiable signal S1, said analysis comprising establishing at least one of the parameters effect, frequency, and durability configuration of said signal S1. The program P comprises routines for comparing said at least one parameter with parameter indication being stored in advance in e.g. the memory portion 540. The program P comprises routines for establishing, at correspondence, that the received identifiable signal S1 comes from a firing unit within own troop. The program P comprises routines for delivering a visual signal S2 in a direction wherefrom the identifiable signal S1 arrived. The program P may be stored in an executable manner or in a compressed state in a separate memory 560 and/or in read/write memory 550.

When it is described that data processing unit 510 performs a certain function it should be understood that data processing unit 510 performs a certain part of the program which is stored in separate memory 560, or a certain part of the program which is stored in read/write memory 550.

Data processing unit 510 may communicate with a data port 599 by means of a data bus 515. Non-volatile memory 520 is adapted for communication with data processing unit 510 via a data bus 512. Separate memory 560 is adapted to communicate with data processing unit 510 via a data bus 511. Read/write memory 550 is adapted to communicate with data processing device 510 via a data bus 514. To the data port 599 e.g. the links 211, 221, 231, 241 and 251 may be connected (see FIG. 2).

When data is received on data port 599 it is temporarily stored in second memory portion 540. When the received input data has been temporarily stored, data processing unit 510 is set up to perform execution of code in a manner described above. The signals received on data port 599 may be used by the apparatus 500 for delivering a visual signal S2 by means of the feedback device 240.

Parts of the methods described herein may be performed by the apparatus 500 with the help of data processing unit 510 running the program stored in memory 560 or read/write memory 550. When the apparatus 500 runs the program, methods described herein are executed.

The foregoing description of the preferred embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated.

1. A method for assessing, from a firing unit, a potential target for said firing unit, comprising the steps of:
visually observing said potential target through direction means;
initiating measuring of a range from said firing unit to the potential target by means of delivering an identifiable signal;
at said potential target, receiving and analysing said signal, said analysis comprising establishing at least one parameter selected from the group consisting of power, frequency, and durability configuration of said signal, characterized by the steps of:
comparing said at least one parameter with parameter indications stored in advance;
on agreement, establishing that the firing unit belongs to own troop; and
delivering a visual signal from the potential target.

2. A method according to claim 1, wherein said identifiable signal is a radar signal, laser signal or IR-laser signal.

3. A method according to claim 1, wherein said parameter indications comprises information about any of the parameters effect and/or frequency and/or durability configuration for measuring in equipment of at least one unit within own troop.

4. A method according to claim 1, wherein the visual signal is delivered from the potential target in a direction towards the firing unit.

5. A method according to claim 1, wherein the visual signal is light visible to the human eye of arbitrary wavelength.

6. A method according to claim 1, wherein the visual signal has a wavelength in a range between 700 and 1000 nm, between 3.0-5.0 micrometre, or between 8.0-12.0 micrometre.

7. A method according to claim 1, further comprising the steps of at the potential target:
establishing a direction from which the identifiable signal was received;
storing information about said established direction;
choosing a direction of delivering for said visual signal.

8. A system for assessing, from a firing unit a potential target for said firing unit comprising:
means through which said potential target visually may be observed;
means for initiating measuring of a range from said firing unit to the potential target by means of means for delivering an identifiable signal;
at said potential target, means (230) for receiving and analysing said signal, said analysis comprising establishing at least one parameter selected from the group consisting of effect, frequency, and durability configuration of said signal,
means for comparing said at least one parameter to parameter indications stored in advance;
means for establishing that the firing unit belongs to own troop, in the case correspondence exists between said at least one parameter and said parameter indications; and
means for delivering a visual signal from the potential target.

9. A system according to claim 8, wherein said identifiable signal is a radar signal, laser signal or IR-laser signal.

10. A system according to claim 8, wherein said parameter indications comprises information about any of the parameters effect and/or frequency and/or durability configuration for measuring in of at least one unit within own troop.

11. A system according to claim 8, wherein the visual signal is delivered from the potential target in a direction towards the firing unit.

12. A system according to claim 8, wherein the visual signal is visible light for the human eye of arbitrary wavelength.

13. A system according to claim 8, wherein the visual signal has a wavelength in a range between 700 and 1000 nm, between 3.0-5.0 micrometre, or between 8.0-12.0 micrometre.

14. A system according to claim 8, further comprising:
means for establishing a direction from which the identifiable signal was received;
means for storing information about said established direction;
means for choosing a delivering direction for said visual signal.

15. A firing unit comprising:
means for receiving and analysing an identifiable signal from a signal delivering firing unit, wherein said identifiable signal is intended for measuring in a range from said signal delivering firing unit to a receiving firing unit, said analysis comprising establishing at least one parameter selected from effect, frequency, and durability configuration of said signal,
means for comparing said at least one parameter to parameter indications stored in advance;
means for establishing that the signal delivering firing unit belongs to own troop, in the case correspondence exists between said at least one parameter and said parameter indications; and
means for delivering a visual signal to the signal delivering firing unit, for indicating, from said receiving firing unit, that said receiving firing unit does not constitute a potential target for said signal delivering firing unit.

16. A firing unit according to claim 15, wherein said firing unit is a military vehicle.

17. A firing unit according to claim 15, wherein said firing unit is a surface combat vessel or helicopter.

18. A computer program for facilitating assessment by a first firing unit whether a second firing unit as a potential target for said first firing unit, said computer program comprising program code stored on a computer-readable storage medium for causing an electronic control unit, or another computer connected to the electronic control unit, of the second firing unit, for performing the steps of:
analysing an identifiable signal having been received from said first firing unit, wherein said identifiable signal is intended for measuring in of a range from said first firing unit to the second firing unit, said analysis comprising:
establishing at least one parameter selected from the group consisting of effect, frequency, and durability of said identifiable signal;
comparing said at least one parameter with parameter indications stored in advance;
at correspondence, establishing that the first firing unit belongs to own troop; and
delivering a visual signal from the second firing unit for indicating that the second firing unit does not constitute a potential target for said first firing unit.

19. A computer program product for a program code stored on a computer-readable storage medium for performing the steps of:
analysing an identifiable signal having been received from said first firing unit, wherein said identifiable signal is intended for measuring in of a range from said first firing unit to the second firing unit, said analysis comprising establishing at least one of the parameters effect, frequency, and durability of said identifiable signal;
comparing said at least one parameter with parameter indications stored in advance;
at correspondence, establishing that the first firing unit belongs to own troop; and
delivering a visual signal from the second firing unit for indicating that the second firing unit does not constitute a potential target for said first firing unit, when said computer program is run on an electronic control unit or another computer connected to the electronic control unit of the second firing unit.
